(19) United States
(12) Patent Application Publication
(10) Pub. No.: US 2024/0050920 A1
(43) Pub. Date: Feb. 15, 2024

(54) Light Reactor and Method for Synthetic Material Production by Means of Light Irradiation

(71) Applicant: Bartenbach Holding GmbH, Aldrans (AT)

(72) Inventors: Christian ANSELM, Wattens (AT); Daniel FÖGER, Silz (AT); Christian REISECKER, Fulpmes (AT); Peter BRÜGGELER, Völs (AT); Johann PANN, Innsbruck (AT); Johannes PRAST, Innsbruck (AT)

(21) Appl. No.: 18/266,557

(22) PCT Filed: Dec. 10, 2021
(86) PCT No.: PCT/EP2021/085266

§ 371 Date: Jul. 12, 2023

(30) Foreign Application Priority Data
Dec. 11, 2020 (DE) 10 2020 133 218.1

(51) Int. Cl. B01J 19/12; C01B 3/04; B01J 31/18; B01J 31/12

(52) U.S. Cl. CPC B01J 19/122; C01B 3/042; B01J 31/1845; B01J 31/12; B01J 31/1815; B01J 2219/00029; B01J 2219/0801; B01J 2219/0877

(57) ABSTRACT

A light reactor for photochemical material production and/or treatment including a receiving space for receiving materials to be irradiated and/or receiving a reaction vessel containing such materials, a plurality of light sources, and a plurality of optical elements, which are distributed in an annular region in a plurality of rows around the receiving space. The optical elements are designed to form light bundles having main emission axes which, from row to row, are tilted differently with respect to a longitudinal axis of the annular region and together form a radiation space constricted between two cone tips, the center of which radiation space is in the central region of the receiving space.

The present invention relates to a light reactor for the synthetic production and/or photochemical treatment of materials, comprising a receiving space for receiving materials to be treated and/or a reaction vessel for the substances to be irradiated, at least one light source, and an optical system for deflecting the light from the light source to the receiving space. The invention further relates to a method for synthetic material production and/or treatment using such a light reactor.

More recently, attempts have been made to produce hydrogen synthetically in light reactors. In this process, water together with a substrate and one or more catalysts is irradiated with light in a receiving space of a light reactor, where a so-called chromophore, i.e., a dye or color carrier, absorbs the light and transfers the light energy to the water via a water reduction catalyst, so that a conversion to H₂ is achieved. The chromophore and other substances used are capable of repeatedly carrying out the above reaction, which identifies the substances as catalysts.

However, the light reactors are also used for other photochemical substance treatments and productions, wherein the materials to be irradiated are usually placed in a reaction vessel, such as a glass flask or a transparent vial, in the receiving space of the container in order to be irradiated specifically with light, which can cause or initiate the desired reaction.

For example, WO 2018/098189 A1 describes a light reactor the reactor housing of which has an opening through which a vial containing the materials to be irradiated can be inserted into a receiving space inside the housing. Through a second housing opening, a UV light emitter arranged outside the housing emits light into the housing, which is deflected inside the housing by several mirrors in order to specifically irradiate the receiving space and the vials arranged there. However, the efficiency of this previously known reactor is limited. On the one hand, the irradiation field in the receiving space is not very homogeneous. In addition, the power density in the area of the glass vials used is relatively low, so that special synthetic applications cannot be started up at all or at least take an excessively long time. At the same time, it is time-consuming to be able to set the spectral range required or useful in each case for different reactions and to convert the light reactor for this purpose.

From the patent document DE 11 2010 005 248 T5 it is known to use LED bands with cluster-like distributed LEDs for photo-induced curing processes, wherein the patent document aims to achieving a more uniform manner of irradiation intensity by such a cluster-like LED array. However, such uniformity is likely to be limited to the large-area photographic papers or image plates to be treated. For a reactor with a receiving space in which there are positioned various materials to be treated, preferably in glass flasks or similar reaction vessels, in dimensions of varying size, the LED bands are not suitable and are hardly capable of deflecting the light emitted in each case specifically to a defined reaction space.

It is the underlying task of the present invention to create an improved light reactor as well as an improved method for synthetic material treatment and/or producing by means of such a light reactor of the type, which avoid the disadvantages of the prior art and further develop the latter in an advantageous manner. In particular, there is to be achieved an efficient irradiation of the materials in the receiving space with high power density and uniformity, which is easily adaptable to different types of reactions and can be precisely controlled.

According to the invention, the task is solved by a light reactor as claimed in claim 1, a method for synthetic material treatment and/or production by light irradiation as claimed in claim 19, and the use of a light reactor as claimed in claim 22. Preferred embodiments of the invention are the subject-matter of the dependent claims.

Thus, it is proposed to distribute a plurality of light sources and associated optical elements annularly around the receiving space of the light reactor to be able to irradiate the receiving space from different directions simultaneously. According to the invention, the plurality of light sources and the plurality of optical elements are distributed in a plurality of rows around the receiving space, each of the optical elements being configured to deflect the respective captured light onto the receiving space located at the center of the annular light source arrangement and optical element arrangement. In this respect, the optical elements are tilted differently with their main emission axes from row to row with respect to the longitudinal axis of the annular region in which the optical elements are distributed around the receiving space, so that the light bundles formed by the optical elements together form a constricted irradiation space which is constricted between two cone tips and has its center in the central region of the receiving space. The irradiation space formed by the light bundles forms an at least approximately rotationally symmetrical body, the circumferential enveloping surface of which is formed by the optical elements arranged in multi-row configuration and the end enveloping surfaces of which are formed by two virtual cones which extend coaxially with respect to the longitudinal axis of the annular region and face each other with their tips, wherein the cone tips can touch or be arranged very close to one another. The irradiation space formed jointly by the light bundles is thus approximately hourglass-shaped or hourglass-like constricted or contoured like an envelope that encloses the constriction region of an hourglass on the outside. The virtual cones which delimit the irradiation space between them do not have to have an exact conical shape in the mathematical sense, which they can nevertheless have, but can form two approximately conical pointed bodies or two mountain peaks which are arranged with their possibly rounded or flattened tips facing each other, at least approximately coaxially.

By constricting the irradiation spaces in this way, the individual light bundles are superimposed in the center of the receiving space, and as a result there can be achieved very high intensities. Such high light intensities allow non-linear reactions, which could not be achieved with lower intensities even with very long irradiation. Similar to a dam break, when a certain intensity is exceeded, an alternative material can be produced or another synthetic material production can be achieved, which could not be achieved below a threshold intensity value even with very long irradiation. Such a two-photon excitation or non-linear optical excitation can also be achieved with light sources which themselves have a lower power, such as LEDs, due to the design and arrangement of the optical elements according to the invention, which produce the radiation field constricted between two cones in the manner.

By using a plurality of light sources and associated light elements, the required spectral range can be variably adjusted in a simple manner. At the same time, a very homogeneous radiation field can be achieved in the central region of the system due to the preferably annular or spherical distribution around the receiving space, so that maximum reaction efficiency is obtained. High power densities can be achieved, which significantly reduce the time required for the desired reaction.

In an advantageous further development of the invention, the light sources and/or optical elements can be arranged with their main emission directions or axes distributed in a matrix-like or cloud-like manner in such a way that the main emission axes of the light sources and/or optical elements are aligned approximately perpendicularly or radially to a common spherical surface around the center of the receiving space. In other words, the light bundles formed by the optical elements fall with their main axes from different sides and directions approximately radially to the center of the receiving space onto the materials to be treated, so that the light bundles incident from different sides meet in the receiving space.

Thus, separate light bundles are formed at the various optical elements, which are not yet superimposed at the optical elements and then meet and superimpose in the central region of the receiving space. Advantageously, the optical elements are distributed in an annular area around the receiving space, so that an overall uniform irradiation and superimposition of the light bundles in the receiving space can be achieved, while at the same time maintaining practical manageability such as the insertion and removal of a receiving vessel.

The optical elements can be distributed point-symmetrically with respect to the center of the receiving space, so that opposite pairs of optical elements have coaxial main emission axes, at least approximately. In this case, all main emission axes can intersect at a common point that forms the center of the receiving space, whereby the common intersection point does not have to be a point in the mathematical sense, but can have a certain extension, so that the main emission axes of the optical elements have, so to speak, a tangle point as a common intersection point.

The light bundles themselves can be formed by the optical elements in each case in a constricted manner like an hourglass, so that the constriction of the light bundle is located in the center of the receiving space, wherein the optical elements distributed in an annular manner in several rows can be aligned in such a way that the constriction regions of the light bundles are superimposed in the center of the receiving space.

The main emission axes of the optical elements arranged in a ring row can have the same tilt relative to the ring longitudinal axis, while the tilt changes from row to row. For example, a central row of optical elements may have main emitting axes extending perpendicularly or radially to the ring longitudinal axis, while the main emitting axes of the optical elements in rows adjacent thereto may be tilted by an acute angle α and an acute angle −α or −β with respect to the longitudinal axis of the annular region, for example in such a way that the main beam axes of the optical elements of an upper row extend downward at an angle of, for example, 70° to 80° with respect to the annular longitudinal axis and the main beam axes of the optical elements of a lower row extend upward at an angle of 70° to 80°. In other words, the main emission axes of the optical elements of one ring row can extend, for example, parallel to a plane perpendicular to the ring longitudinal axis, while the main emission axes of the optical elements of another ring row can extend inclined to the plane perpendicular to the ring longitudinal axis. The angles of inclination can change stepwise from row to row, wherein the angles of inclination of the optical elements arranged in a row can be the same.

In particular, the optical elements can be arranged next to or on top of each other in a matrix-like or cloud-like distribution on a common spherical surface and have essentially the same distance from the center of the receiving space to be irradiated. In principle, however, it would also be possible to arrange the optical elements at different distances from the center of the receiving space to be irradiated, for example, to position them on two or three spherical surfaces with different spherical diameters, wherein the optical elements arranged in this staggered manner can nevertheless be arranged with their main emission axes radial to the center of the receiving space, or the plurality of spherical surfaces of different diameters on which the optical elements are distributed can be concentric.

In particular, the light sources and/or optical elements are distributed in an arrangement close to each other around the receiving space. In order to achieve the densest possible arrangement on a common, curved—virtual—surface, the optical elements can be placed in spaces arising between adjacent optical elements or nested in one another in order to make the best possible use of the spaces arising due to the outline contours of the optical elements. In this way, a high-power density can be achieved with an overall small design.

Advantageously, the light sources and/or optical elements can be arranged on an annular strip of a common spherical surface whose spherical center forms the center of the receiving space.

The light sources and/or optical elements may advantageously be arranged in at least two or three rows above and/or next to each other around the receiving space, wherein the rows may each form a circular ring and/or the optical elements in different rows may have at least approximately the same distance from the center of the receiving space.

In particular, the optical elements arranged in different rows can have mutually tilted main emission axes.

To enable the optical elements to be arranged as tightly as possible around the receiving space, the optical elements in adjacent rows can be arranged offset relative to each other, so that an optical element in a first row is arranged approximately centrally between two adjacent optical elements in an adjacent second row, naturally showing the transverse offset corresponding to the row width. The offset of the optical elements in the first row relative to the optical elements in the second row is given in the longitudinal direction of the row and can be approximately half the pitch or half the distance between the centers of two adjacent optical elements in the adjacent row. If, for example, 12 optical elements are arranged in an annular row so that the pitch between two adjacent optical elements is 360°/12, i.e., 30°, the adjacent circular row of also 12 optical elements can be rotated by 15° with respect to the first row.

If three or more rows of optical elements are provided, the optical elements in a first and third row can be arranged to overlap each other or define connecting lines between two optical elements in each case, which are perpendicular to the longitudinal directions of both rows. Regardless of the exact alignment of the connecting lines through the nearest pairs of optical elements in the first and third rows, the optical elements in the second or intermediate row can be arranged approximately centrally to the connecting lines through the optical elements of the first and third rows.

Depending on the diameter of the optical elements, different numbers of rows of optical elements and/or different numbers of optical elements per row can be provided.

For example, 5 to 50 or 10 to 40 or 15 to 30 optical elements can be distributed in the circumferential direction around the receiving space, wherein, for example, 2 or 3 or 4 rows with a comparable number of optical elements in each case can be provided one above the other in the order of magnitude mentioned, so that, for example, in the case of three rows, approximately 50 to 70 optical elements can form an approximately spherical ring-shaped optical element field.

Considering the overall approximately spherical optical element field, the optical element field may define a spherical ring-shaped contour extending around the receiving space and open towards at least one insertion opening of the receiving space. In particular, the spherical optical element field can be formed to be open towards the top and towards the bottom in order to be able to insert a reaction vessel in a simple manner from above into the receiving space within the spherical optical element field and to provide a contact surface for the reaction vessel to be inserted from below. In principle, however, it would also be possible to make the spherical optical element field open only towards the receiving space and, for example, to close the optical element field also towards the bottom, for example if the reaction vessel can be held in the receiving space from above by a holder.

Considering a cross-section of the spherical optical element field, the spherical segments can include a segment angle in the region of 30° to 90° or 40° to 70°, resulting in a good compromise between high power density and ease of inserting the reaction vessel.

Advantageously, the optical elements can be rotationally symmetrical and/or have a preferably circular circumferential contour, whereby the optical elements can be aligned with their axes of rotation to a common center of the receiving space.

If the optical elements have a polygonal, e. g. hexagonal, cross-sectional contour, the band-shaped circumferential portions can be brought into alignment with each other by corresponding rotation about the axis of rotation. In particular, however, a circular circumferential contour can also be provided.

In further development of the invention, one optical element can be assigned to each approximately point-shaped light source, whereby an LED or an LED cluster with preferably differently colored individual LED elements can be provided as the light source. For example, a cluster-like LED device may be provided with 2, 3, or 4 individual LED elements arranged immediately adjacent to each other and mounted on a common carrier board and associated with an optical element that captures the emitted light of the LED cluster and deflects it to the center of the receiving space.

Advantageously, the LEDs can have their main emission axes radially aligned with a common spherical surface and/or aligned with the center of the receiving space. Regardless of a radial main emission axis or one directed toward a common center, the LEDs can advantageously be aligned so that the direct light emitted is directed toward the center of the receiving space. In other words, the LEDs can see into the receiving space.

The optical elements can basically be formed in different ways, whereby lenses in particular can be provided as optical elements which can advantageously capture the light of the respectively assigned light source completely and can form it into a light bundle which is directed towards the center of the receiving space.

Alternatively, or additionally, at least one or more light sources can also be assigned a reflector as an optical element, which captures the light emitted by the light source and forms it into a light bundle that is directed to the center of the receiving space.

It is also possible to configure a part of the optical elements as a lens and another part of the optical elements as a reflector.

Alternatively, or additionally, mixed forms of lenses and reflectors are also possible, for example in such a way that a reflector collar is molded onto a lens and/or an outer surface of a lens has a reflective coating.

Advantageously, light sources of different light colors can be provided so that different light colors or different spectral distributions can be achieved by controlling the light sources differently. Differently colored light sources can be associated with different optical elements. If LED clusters with differently colored individual LED elements are used in the above manner, different light colors can also be produced at one optical element.

Advantageously, light sources of the same color are arranged on opposite sides of the receiving space, in particular arranged point-mirror symmetrically opposite each other with respect to the center of the receiving space, in order to produce a homogeneous radiation field for the respective color channel and to facilitate sensor-based in-situ control or detection.

Advantageously, light sources of at least one color can be formed or controlled in a dimmable manner to enable multispectral irradiations of the receiving space and/or to have a greater variability when adjusting the light spectra.

The invention is explained in more detail below on the basis of a preferred exemplary embodiment and the corresponding drawings. The drawings show:

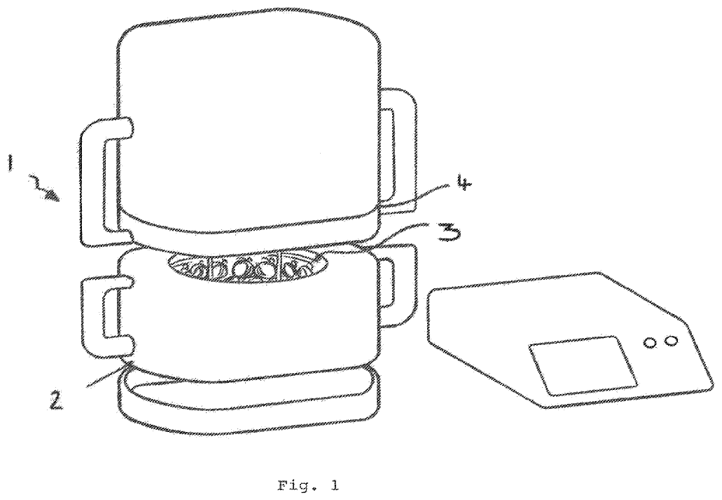

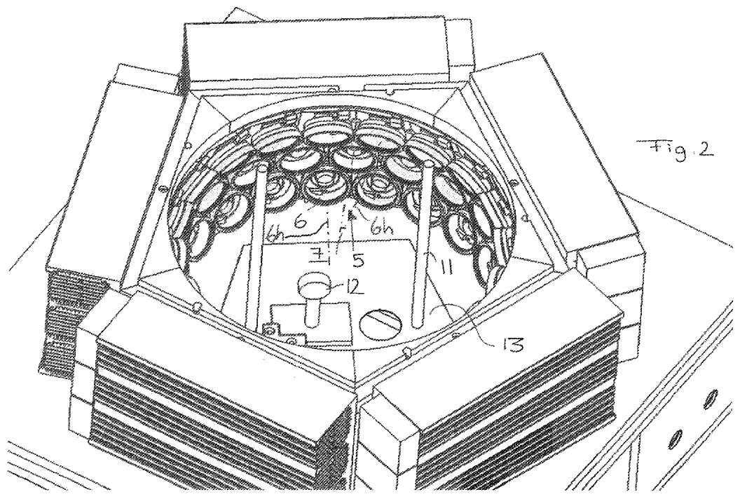

FIG. 1: a perspective view of a light reactor according to an advantageous embodiment of the invention, wherein the reactor has a closable opening at its top for inserting the reaction vessel,

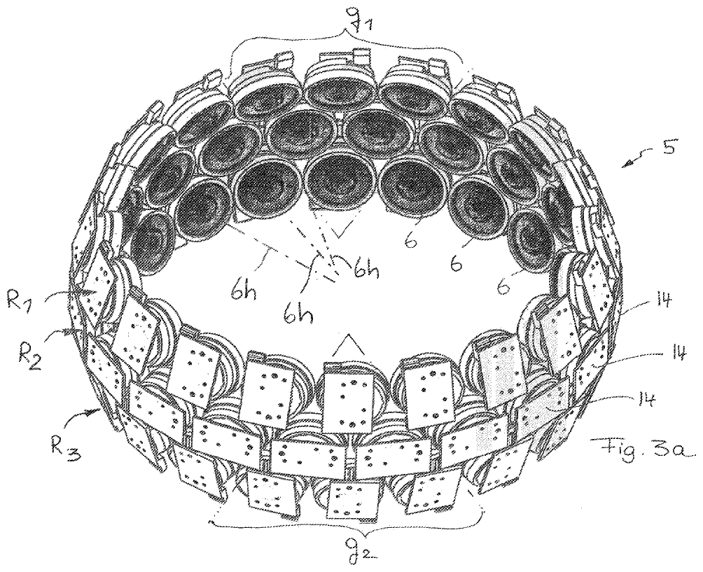

FIG. 2: a perspective view of the receiving space of the light reactor and the optical elements arranged around it for irradiation of a reaction vessel positioned in the receiving space,

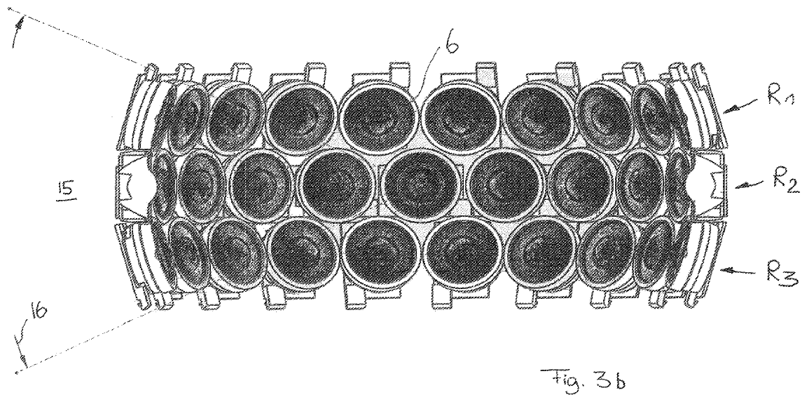

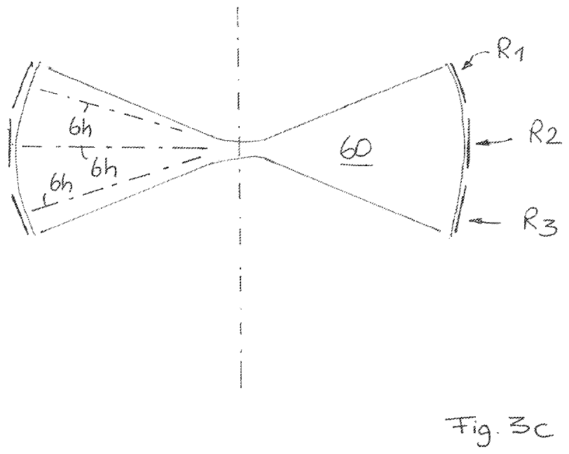

FIG. 3: a schematic representation of the spherical optical element field around the receiving space, where FIG. 3A shows the different color channels arranged point-symmetrically opposite each other in perspective and FIG. 3B shows a sectional view of the spherical arrangement of the optical elements and FIG. 3C shows the irradiation space constricted between two cones, which is formed by the light bundles of all emitters together,

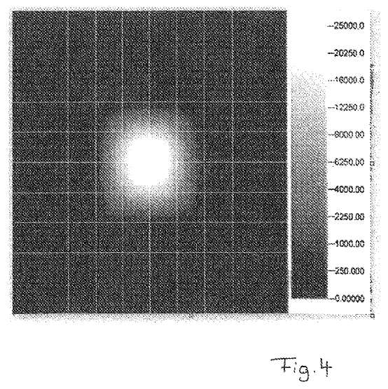

FIG. 4: a representation of the energy field distribution in the center of the receiving space orthogonal to the central radiation axis of a respective light bundle, and

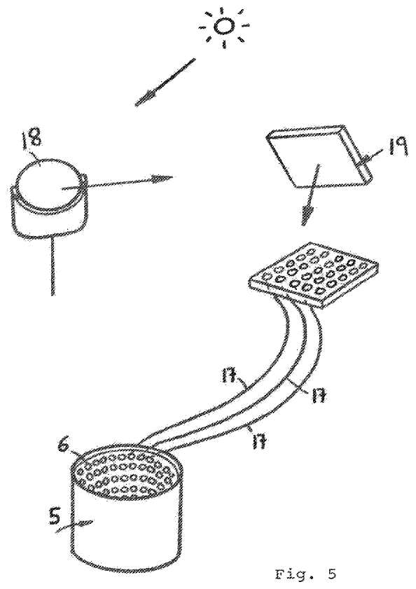

FIG. 5: a schematic representation of an embodiment according to which daylight is supplied to the optical elements via light guides and the ends of the light guides act as light sources.

As shown in FIG. 1, the light reactor 1 may comprise a closed or closable housing 2, which may for example be substantially formed cylindrically and may stand upright with a contact surface on the ground.

A closable filling opening 3 can be provided on a top side of the housing, which can be closed by a lid 4.

An optical element field 5 is provided inside the housing 2, which comprises a plurality of optical elements 6 and can extend approximately annularly around a receiving space 7, which is accessible through the filling opening 3 of the housing 2 and into which one or more reaction vessels 8, for example in the form of vials or glass flasks, can be inserted through the filling opening 3—for example from above.

As FIG. 2 shows, a mounting bracket 11 can be provided in the receiving space 7 for holding or attaching the reaction vessels 8. Alternatively, however, it would also be possible to simply place the reaction vessels 8 on a base 13 or a platform-like support surface inside the housing 2. It is also possible to suspend the reaction vessel 8 from a lid of the receiving space 7, for example from the lid 4.

As FIGS. 2 and 3 show, the optical element field 5, viewed as a whole, is formed in the manner of a spherical ring which is open on the one hand towards the base 13 of the housing 2 and on the other hand towards the filling opening 3 of the housing 2.

In particular, the optical elements 6 can be arranged distributed in a matrix-like manner on a spherical surface 9, so that the optical elements 6 each face the center of the receiving space 7 or are aligned with the main emission axes in each case to the center 10 of the receiving space 7 inside the optical element field 5.

The optical elements 6 can advantageously be formed as lenses, which can be injection molded from transparent silicone, for example, or manufactured in another way, for example from another plastic or also from glass. The optical elements 6 can be formed rotationally symmetrical with their axis of rotation directed to the center 10 of the receiving space 7. For example, circular or even polygonal, for example hexagonal, lenses and/or reflectors can be provided in cross-section. If hexagonal reflectors and/or lenses are provided, there can be achieved for example, a practically gap-free, placing of the optical elements 6 next to each other on the arrangement surface 9.

When arranged on the spherical surface 9, the optical elements 6 have substantially the same distance from the center of the receiving space 7.

As shown in FIGS. 2 and 3, the optical elements 6 can be distributed in several annular rows on the spherical surface 9, wherein the optical elements 6 in one row can be arranged offset to the optical elements 6 in the other row in order to be able to arrange the optical elements 6 as a whole as close as possible to each other.

For example, if we consider connecting lines through the centers of two superimposed optical elements 6 in the uppermost row and in the lowermost row, respectively, the optical elements 6 in the middle, intermediate row are arranged centrally between the connecting lines. In other words, the rows of optical elements 6 may be rotated relative to each other by half the pitch between each two adjacent optical elements 6 in a row. If, for example, optical elements 6 are provided in the middle row 20, the upper and lower rows can each be rotated by one 40th of 360° relative to the middle row, cf. FIG. 3.

This allows the space between two adjacent lenses in a row to be used for positioning the optical elements of the adjacent rows. Accordingly, the distance between two rows, measured between the center longitudinal lines of the rows, can be smaller than the diameter of the optical elements 6.

The optical elements 6 can have identical contours, in particular they can all be formed rotationally symmetrical and have circular contours, see FIG. 2 and FIG. 3.

Light sources 14 can be arranged on an outer side of the optical elements 6, which can preferably be formed as LEDs or LED clusters. Irrespective of the configuration of the light sources 14 as LEDs, each optical element 6 can be assigned its own light source, wherein the plurality of light sources 14 can advantageously also be distributed on a spherical surface, the spherical center of which can correspond to the center 10 of the receiving space 7, in particular in such a way that the main emission axes of the light sources 14 are directed towards the center 10 of the receiving space 7.

Considering a sectional plane 15, which may form the major axis of the spherical optical element field 5 by a longitudinal section, the optical element field 5 may extend over a spherical sector with a sector angle 16 in the region of 30° to 90° when viewed as a whole, cf. FIG. 3B.

The light sources 14 can emit differently colored light, wherein it would in principle be possible to assign a multicolored LED cluster as light source 14 to each optical element 6 in order to be able to produce different light colors at each optical element 6. Alternatively, however, it may be sufficient to provide different light colors at different optical elements 6, advantageously with the possible color channels arranged point-symmetrically opposite each other to produce a homogeneous energy field for the single-color channel and to facilitate sensor-based in-situ control capability.

For example, the optical element field 5 can be subdivided into V-shaped color channel segments in each case, with color channel segments of the same color lying opposite each other and being aligned with respect to each other in a point-mirror symmetrical manner. For example, a green color channel segment G1 or its optical elements 6 can form an upright triangle, while the opposite green segment G2 forms an upside-down triangle, see FIG. 3A.

The optical elements 6 are configured to produce a very uniform energy field in the center of the receiving space 7.

FIG. 4 shows the uniform manner of energy field distribution in the center. For example, partial view a of FIG. 4 shows the energy field distribution of the cold white channel in the center of receiving space 7 orthogonal to the central radiation axis, i.e., in the sectional plane 15 drawn in FIG. 3. The grid lines in FIG. 4 define a 30×30 mm grid, from which it can be seen that the energy field distribution is very homogeneous or uniform manner.

Partial view B of FIG. 4 shows the energy field distribution of the UV light channel in the center orthogonal to the central radiation axis and also illustrates a very uniform distribution.

Advantageously, the various color channels can be dimmably controlled in order to achieve multispectral excitation by switching on one or more dimmable color channels.

In the arrangement shown as an example in FIG. 3, in addition to the cold white channel, a blue light channel, a green light channel and a red-light channel are also provided, each of which is formed by point-mirror symmetrically opposite each other segment areas of the spherical arrangement of optical elements 5.

However, depending on the irradiation tasks, other LED and optical element arrangements can be selected.

Advantageously, the light reactor 1 can be used to produce hydrogen, in particular by irradiation of water and a substrate with light and by using one or more catalysts. In this respect, sunlight can be absorbed by a so-called chromophore, i.e., a color carrier and/or a dye, the chromophore transferring the light energy to the water via a water reduction catalyst. Using this energy, the water is converted to molecular hydrogen H₂.

The chromophore regenerates by producing an oxidation product, which can ideally be molecular oxygen O₂, from a substrate. H₂ can be used as a fuel, and depending on the system design, the oxidation product can be used as a feedstock.

The chromophore and other substances used are capable of performing this reaction repeatedly, and this behavior identifies the substances as catalysts. The lifetime and the reaction rate of the catalysts are essential factors to describe the quality of the system. In this respect, it is important to maximize the product of these factors, the so-called Turnover Number (TON), in order to achieve a high molecular efficiency. The turnover number indicates how much hydrogen is obtained from a given amount of the catalyst system under the influence of light.

Advantageously, [Ru₂(bpy)₄(trans,trans,trans-tetra-((bis-2-methoxyphenyl)phosphino)cyclobutane)](PF₆)₄ may be used as chromophore (catalyst 1) and/or [PdCl₂(N,N-bis((bis-2-methoxyphenyl)phosphinomethyl)ethylamine] as water reduction catalyst. Water and/or ascorbic acid can be used as substrates and hydrogen and/or dehydroascorbic acid can be obtained as products.

In the embodiment according to FIGS. 2 and 3, as light sources 14, there are provided LEDs and LED clusters, respectively. Alternatively, however, at least some of the light sources 14 may be formed by the exit ends of light guides 17, which may be associated with a respective optical element 6. As FIG. 5 shows, sunlight, for example, can be guided to the optical elements 6 of the light reactor 1 via the aforementioned light guides 17. The sunlight can, for example, be directed via a heliostat 18 and a suitable deflecting optics 19 to coupling elements which feed the sunlight into the light guides 17 in order to then deflect the light via these to the optical elements 6.

1. A batch reactor for photochemical material production and/or treatment comprising:
a receiving space accessible through a filling opening in a reactor housing;
at least one light source; and
an annular, spherically contoured optical element field open to the filling opening and formed by optical elements arranged substantially equidistant from a central point in the receiving space and within an annular region of a spherical surface extending around the central point in the receiving space;
wherein the optical elements each have a main emission axis; and
wherein the main emission axes are distributed perpendicular to the spherical surface extending around the central point in the receiving space.

2. The batch reactor according to claim 1, wherein the optical elements are distributed within the annular region in rows around the receiving space; and
wherein the optical elements are configured to form light bundles having the main emission axes which, from row to row, are tilted differently with respect to a longitudinal axis of the annular region and together form an irradiation space constricted between two cone tips, the center of which irradiation space lies on the central point of the receiving space.

3. The batch reactor according to claim 1, wherein components selected from the group consisting of the at least one light source, the optical elements, and a combination thereof are distributed in a matrix-like or cloud-like manner on an at least approximately spherical common surface.

4. (canceled)

5. The batch reactor according to claim 2, wherein the rows are rotated relative to each other and thereby the optical elements of adjacent rows are offset relative to each other, the offset being substantially equal to half the pitch between adjacent optical elements in a row.

6. The batch reactor according to claim 1, wherein the optical elements are rotationally symmetrical, and are aligned with axes of rotational symmetry with the central point of the receiving space.

7. The batch reactor according to claim 1, wherein the optical elements are distributed point-symmetrically opposite each other with respect to the central point of the receiving space; and
wherein mutually opposite optical elements have mutually coaxial main emission axes.

8. The batch reactor according to claim 1, wherein at least a portion of the optical elements form a lens.

9. The batch reactor according to claim 1, wherein at least a portion of the optical elements form a reflector.

10. The batch reactor according to claim 1 comprising a plurality of light sources;
wherein at least two of the light sources are differently colored light sources.

11. The batch reactor according to claim 1 comprising a plurality of light sources;
wherein light sources of the same light color are distributed point-symmetrically opposite each other with respect to the central point of the receiving space.

12. The batch reactor according to claim 1 comprising a plurality of light sources;
wherein the light sources form a plurality of separately controllable color channels; and
wherein at least one-color channel is configured to be dimmable so that multispectral irradiation can be set.

13. The batch reactor according to claim 1 further comprising a sensor system within or on the optical element field and configured to detect the light intensity and/or irradiation spectrum in the receiving space.

14. The batch reactor according to claim 13 further comprising a control means configured to variably drive the light sources depending on a sensor signal from the sensor system.

15. The batch reactor according to claim 1, wherein the optical elements are arranged within the annular region around the receiving space so that in more than 50% of the area of the annular region, there are allocated the optical elements.

16. The batch reactor according to claim 1 further comprising light guides and a coupling device;
wherein at least a portion of the light sources are formed by end portions of the light guides or outcoupling elements connected thereto; and
wherein the light guides are connected to the coupling device for coupling sunlight.

17. The batch reactor according to claim 16, wherein the coupling device comprises a heliostat.

18. The batch reactor according to claim 1, wherein the filling opening can be closed by a lid.

19. (canceled)

20. The method according to claim 23, wherein the sample comprises a mixture of materials, water, a substrate and at least one catalyst so that the water is converted to molecular hydrogen H₂.

21. The method according to claim 1, wherein the sample further comprises ascorbic acid and Ru₂(bpy)2(transe); and
wherein one of the at least one catalyst comprises PdCl₂(PNP^{Et}).

22. Producing molecular hydrogen H₂ using the batch reactor of claim 1.

23. A method for photochemical material production and/or treatment using the batch reactor of claim 1 comprising:
radiating a sample located in the receiving space by a plurality of light beams generated separately by a plurality of the light sources and a plurality of the optical elements;
wherein the light sources and optical elements are distributed in a matrix-like manner within the annular region and superimposed in the receiving space of the receiving space.
